(19) United States
(12) Patent Application Publication
(10) Pub. No.: US 2017/0045380 A1
(43) Pub. Date: Feb. 16, 2017

(54) ROTARY SENSING DEVICE

(71) Applicant: TDK Corporation, Tokyo (JP)

(72) Inventors: Kunihiro UEDA, Tokyo (JP); Hiraku HIRABAYASHI, Tokyo (JP)

(21) Appl. No.: 15/196,155

(22) Filed: Jun. 29, 2016

(30) Foreign Application Priority Data
Aug. 11, 2015 (JP) 2015-159058

(51) Int. Cl. G01D 5/16

(52) U.S. Cl. CPC G01D 5/16

(57) ABSTRACT

A rotary sensing device that can accurately detect a rotation direction, even if a rotating body rotates at a high speed, when a gap between a plurality of subjects for detection in a rotating body varies is equipped with first to ^{Nth} sensor elements that are aligned to oppose the rotating body, which is rotatable in a rotation direction that can be either a normal rotation direction or a reverse rotation direction, and in parallel in respective order along the rotation direction, and that output first to Nth (N≧3) sensor signals based upon the rotation of the rotating body, respectively, and a rotation direction detecting part that detects the rotation direction of the rotating body based upon each sensor signal output from each sensor element, and the rotation direction detecting part detects the rotation direction of the rotating body from a first differential signal that is obtained from the first sensor signal and the M^{th} (3≦M≦N) sensor signal, and a second differential signal obtained from the first sensor signal and the L^{th} (2≦L≦M-1) sensor signal.

### CROSS REFERENCE TO RELATED APPLICATION

The present application is based on and claims the benefit of priority of Japanese Patent Application No. 2015-159058, tiled on Aug. 11, 2015, the disclosure of which is incorporated herein by reference.

### TECHNICAL FIELD

The present invention relates to a rotary sensing device that detects a rotational state of a rotating body.

### BACKGROUND TECHNOLOGY

Conventionally, a rotary sensing device for detecting a rotational state, such as a rotational position, the rotary speed or the rotation direction of a rotating body is used for various uses. As the rotary sensing device, a device that is equipped with a gear wheel having a plurality of teeth made with a magnetic material, a rotating body, such as a multipole magnetizing magnet having a plurality of north poles and south poles alternately arranged in a circumferential direction, and a magnetic sensor disposed opposite to the rotating body is known, and the magnetic sensor detects a change in direction of a magnetic field in association with the rotation of the rotating body, and outputs a signal indicating a relative positional relationship between the rotating body and the magnetic sensor.

In such a rotary sensing device, in order to detect and determine the direction of rotation (the normal rotation direction or reverse rotation direction) of the rotating body, two phase shifting signals are required. Consequently, as the magnetic sensor in the rotary sensing device, a sensor where two magnetic sensor elements are disposed so as to allow the signal phases to shift from each sensor element by 90° is known.

In a rotary sensing device having such a configuration, since signal offset occurs due to an assembly error of the magnetic sensor elements or the like, there is the problem that noise resistance of the rotary sensing device becomes poor. In order to solve such problem, a rotary sensing device in which three magnetic sensor elements are aligned in the rotation direction of a rotating body, and that detects the rotation direction based upon the differential outputs of the two adjacent magnetic sensor elements, is proposed (see Patent Literature 1).

### PRIOR ART LITERATURE

[Patent Literature] Japanese Patent Application Laid-Open No. 2002-267494

### SUMMARY OF THE INVENTION

### Problem to be Solved by the Invention

In the rotary sensing device described in Patent Literature 1, a plurality of north poles and south poles are alternately aligned as a rotating body in a magnetizing rotor as the subject for detection in the magnetic sensor elements. Gaps of adjacent magnetic sensor elements out of three magnetic sensor elements are set at ¼ of the distance between two adjacent north poles (or two south poles) of the magnetizing rotor Since the rotation direction is detected based upon differential outputs of two sets of adjacent magnetic sensor elements, the phase of each differential output can be shifted by 90°, and the rotation direction can be detected based upon each differential output. In other words, it becomes possible to detect the rotation direction because the phase of each differential output is shifted by 90°.

However, in a magnetizing rotor where a plurality of north poles and south poles are alternately aligned, since the distances between two adjacent north poles (or two south poles) vary, even if three magnetic sensor elements are positioned and arranged with a high degree of accuracy, noise is increased depending upon the magnetizing accuracy in the magnetizing rotor, and noise resistance cannot be improved, as information relating to the obtained rotational state contains errors.

Further, because the rotation direction is detected based upon the differential output of the two adjacent magnetic sensor elements, if the rotating body rotates at a high speed, differential outputs where the phase is shifted from each other may overlap, making it extremely difficult to detect the rotation direction.

Furthermore, even when a gear wheel having a plurality of teeth is used as the rotating body, since the gap between two adjacent teeth can vary, problems similar to those above may occur.

In light of the above problem, the objective of the present invention is to provide a rotary sensing device that can accurately detect the rotation direction even if the gap between/among a plurality of subjects for detection in a rotating body varies, and in particular even when such rotating body rotates at high speed.

### Means for Solving the Problem

In order to solve the above problem the present invention provides a rotary sensing device, including:

first to N^{th} sensor elements (N is an integer greater than or equal to 3) that oppose a rotating body, which is rotatable in a normal rotation direction or a reverse rotation direction, and that are sequentially aligned along the normal or reverse rotation direction of the rotating body, and that output first to N^{th} sensor signals based upon rotation of the rotating body, respectively, and

a rotation direction detecting part that detects the rotation direction of the rotating body based upon the first to ^{Nth} sensor signals output from the first to N^{th} sensor elements, wherein

the rotation direction detecting part detects the rotation direction of the rotating body from the first differential signal obtained from the first sensor signal and the M^{th} sensor signal (M is an integer that is less than or equal to N and greater than or equal to 3) sensor signal and a second differential signal obtained from the first sensor signal and the L^{th} sensor signal (L is an integer that is less than or equal to M-1 and greater than or equal to 2) .

According to the above invention, since the distance between sensor elements that output two sensor signals (the first sensor signal and the M^{th} sensor signal) for acquiring the first differential signal is different from the distance between the sensor elements that output two sensor signals (the first sensor signal and the L^{th} sensor signal) for acquiring the second differential signal, the first differential signal and the second differential signal appear as waveforms with a different amplitude, and the rotation direction of the rotating body is detected from the two differential signals with different amplitude; thus even if the gaps between the subjects for detection in the rotating body vary or if the rotating body rotates at a high speed, the rotation direction can be accurately detected.

In the invention above, it is preferable that N is 3 and that the rotation direction detecting part detects the rotation direction of the rotating body based upon the first differential signal obtained from the first sensor signal and the third sensor signal and the second differential signal obtained from the first sensor signal and the second sensor signal.

In the invention above, it is preferable that the gap between the first sensor element and the second sensor element be smaller than that between the second sensor element and the third sensor element.

In the invention above, it is preferable that the rotation direction detecting part detects the rotation direction of the rotating body based upon the positive or negative status of the second differential signal at the time of zero-crossing of the first differential signal.

In the invention, it is preferable that the rotation direction detecting part detects the rotation direction of the rotating body based upon the positive or negative status before and after the first differential signal crosses zero and the positive or negative status of the second differential signal when the first differential signal crosses zero.

In the invention, the rotating body is a gear wheel having a plurality of teeth made from a magnetic material, and the gap between the first sensor element and the N^{th} sensor element is smaller than the gap of two adjacent teeth of the gear wheel. Further, the rotating body comprises a plurality of north poles and south poles that are aligned alternately in the circumferential direction, and the gap between the first sensor element and the N^{th} sensor element is smaller than the gap between two adjacent north poles.

In the invention, TMR elements or GMR elements may be used as the first to N^{th} sensor elements.

### Effect of the Invention

According to the present invention, if the gaps of a plurality of detection subjects in a rotating body vary, even if such a rotating body rotates at a high speed in particular, a rotary sensing device that enables accurate detection of the rotation direction can be provided.

### BRIEF DESCRIPTION OF DRAWINGS

FIG. 1 is a perspective view showing a schematic configuration of a rotary sensing device relating to one embodiment of the present invention.

FIG. 2 is a partially-enlarged diagram showing an arrangement of a magnetic sensor relative to a gear wheel in one embodiment of the present invention.

FIG. 3 is a circuit diagram schematically showing one mode of a circuit configuration of the magnetic sensor in one embodiment of the present invention.

FIG. 4 is a perspective view showing a schematic configuration of an MR element as a magnetic detecting element in one embodiment of the present invention.

FIG. 5 is a block diagram schematically showing a configuration of the magnetic sensor in one embodiment of the present invention.

FIG. 6 shows analog waveforms of first to third sensor signals in one embodiment of the presentation.

FIG. 7 shows analog waveforms of first and second differential signals in one embodiment of the present invention.

FIG. 8 shows waveforms of a pulse signal output from an operation part in one embodiment of the present invention.

FIG. 9 is a circuit diagram schematically showing another mode of the circuit configuration of the magnetic sensor in one embodiment of the present invention.

### MODE FOR CARRYING OUT THE INVENTION

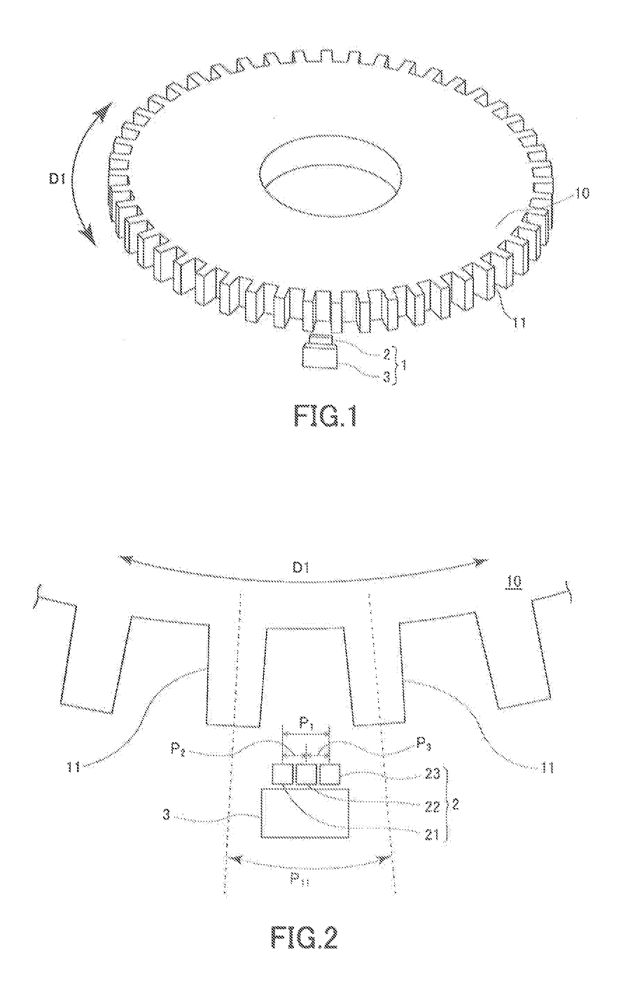

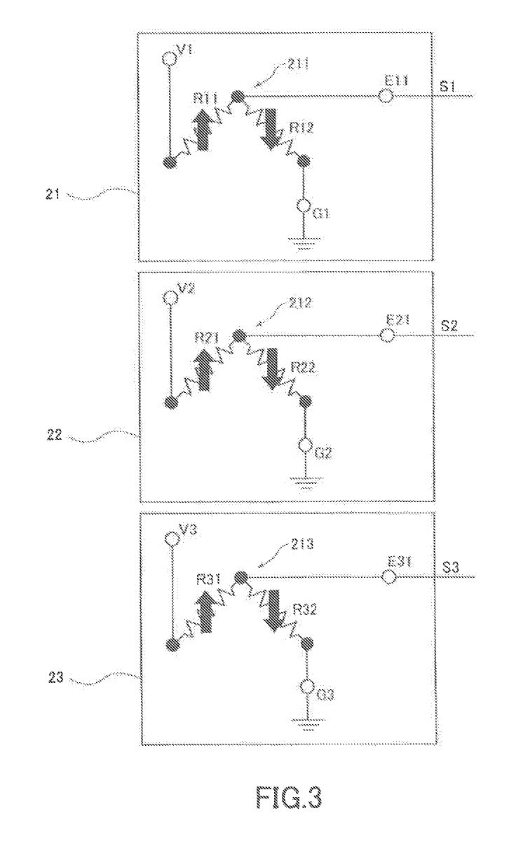

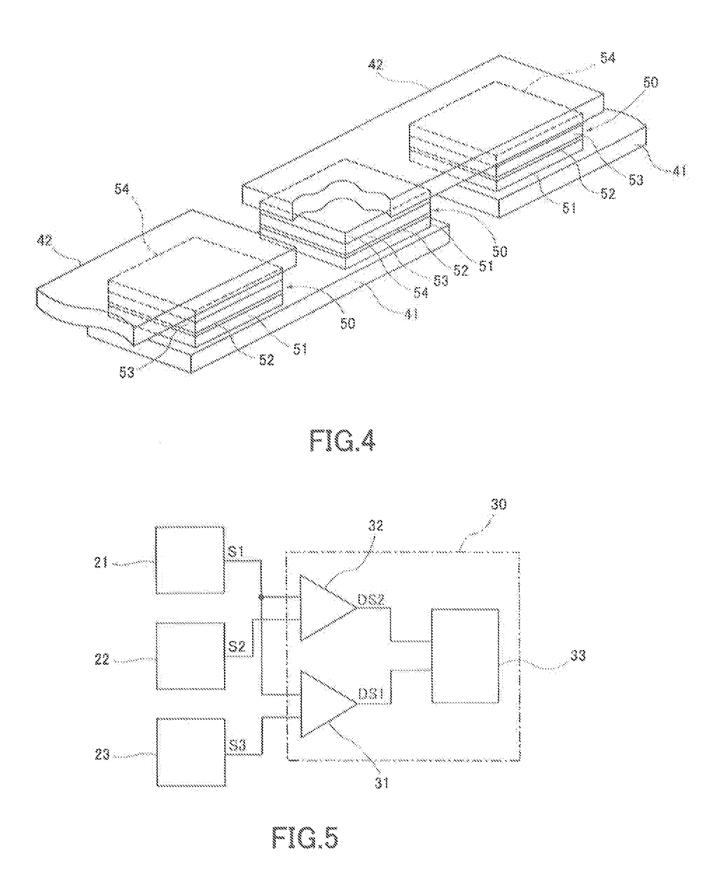

Embodiments of the present invention are described in detail with reference to the drawings. FIG. 1 is a perspective view showing the schematic configuration of a rotary sensing device relating to the present embodiment; FIG. 2 is a partially-enlarged diagram showing the arrangement of a magnetic sensor relative to a gear wheel in the present embodiment; FIG. 3 is a circuit diagram schematically showing one mode of a circuit configuration of the magnetic sensor in the present embodiment; FIG. 4 is a perspective view showing the schematic configuration of an MR element as a magnetic detecting element in the present embodiment; and FIG. 5 is a block diagram schematically showing the configuration of the magnetic sensor in the present embodiment.

As shown in FIG. 1, a rotary sensing device 1 relating to the present embodiment is equipped with a magnetic sensor 2 opposing the outer circumferential surface of gear wheel 10 that is rotatable in a first direction (normal direction and reverse rotation direction) D1 and a bias magnetic field generator 3 that is arranged so as to be interposed between the magnetic sensor 2 with the gear wheel 10. The gear wheel 10 is made from magnetic material, and a plurality of teeth 11 are formed around its outer circumferential surface. Furthermore, in the example shown in FIG. 1, the number of teeth 11 in the gear wheel 10 is 48, but the number of teeth 11 is not particularly limited.

The magnetic sensor 2 has a first magnetic sensor part 21, a second magnetic sensor 22 and a third magnetic sensor part 23. The first to third magnetic sensor parts 21 to 23 are in parallel on a straight line so as to oppose to the teeth 11 of the gear wheel 10, and to be along the rotatable direction (first direction D1) of the gear wheel 10.

The gap P₁ between the first magnetic sensor part 21 and the third magnetic sensor part 23 should be within the gap P₁₁ between adjacent teeth 11 of the gear wheel 10, and it is preferable that the gap P₁ between the first magnetic sensor part 21 and the third magnetic sensor part 23 is as small as possible. If the gap P₁ between the first magnetic sensor part 21 and the third magnetic sensor part 23 is minimized, when the magnetic sensor 2 (the first to third magnetic sensor parts 21 to 23) and the operation part 30, described hereafter, are incorporated in one chip, the size of the chip can be reduced. The gap P₁ between the first magnetic sensor part 21 and the third magnetic sensor part 23 is preferably approximately ¼ of the gap P₁₁ between adjacent teeth 11, is more preferably approximately ⅙ of the gap P₁₁ between the adjacent teeth 11 and particularly is preferably approximately 1/9 to ⅙ of the gap P₁₁ between the adjacent teeth 11, and there are forty-eight variable gaps P₁₁ between the adjacent teeth 11 in one rotation of the gear wheel 10. Consequently, the gap P₁ between the first and third magnetic sensor parts 21 and 23 should be smaller than all of the forty-eight gaps P₁₁, and it is unnecessary to position the first to third magnetic sensor parts 21 to 23 relative to the gear wheel 10 (teeth 11). The gap P₁₁ between the adjacent teeth 11 of the gear wheel 10 is equivalent to one cycle of the first to third sensor signals S1 to S3 output by the first to third magnetic sensor parts 21 to 23, which is 1/48 rotation of the 360° electric angle of gear wheel 10, or a 7.5° rotation angle, in the present embodiment. The gap P₁ between the first magnetic sensor part 21 and the third magnetic sensor part 23 is, in other words, within the electric angle, which is preferably 90°, and more preferably approximately 60°, and particularly preferably approximately 40° to 60°.

The gap P₂ between the first magnetic sensor part 21 and the second magnetic sensor part 22, and the gap P₃ between the second magnetic sensor part 22 and the third magnetic sensor part 23, are not particularly limited, but it is preferable that the gap P₂ between the first magnetic sensor part 21 and the second magnetic sensor part 22 be smaller than the gap P₁ between the second magnetic sensor part 22 and the third magnetic sensor part 23. As described hereafter, in the present embodiment, the rotation direction (normal rotation direction or reverse rotation direction) of the gear wheel 10 is detected based upon the first differential signal DS1 to be generated from the first sensor signal S1 output from the first magnetic sensor part 21 and the third sensor signal S3 output from the third magnetic sensor part 23, and the second differential signal DS2 generated from the first sensor signal S1 and the second sensor signal S2 output from the second magnetic sensor part 22. In detecting the rotation direction, because the amplitudes of the first differential signal DS1 and the second differential signal DS2 are different, the rotation direction of the gear wheel 10 can be assuredly detected even if the gear wheel 10 rotates at high speed. Consequently, because the gap P₂ between the first magnetic sensor part 21 and the second magnetic sensor part 22 is smaller than the gap P₃ between the second magnetic sensor part 22 and the third magnetic sensor part 23, the amplitude of the first differential signal DS1 and the second differential signal DS2 can be readily differentiated, and the rotation direction of the gear wheel 10 can be more certainly detected. Furthermore, in the example shown in FIG. 2, the left to right direction is the normal rotation direction, and the right to left direction is the reverse rotation direction.

The first to third magnetic sensor parts 21 to 23 in the present embodiment include at least one magnetic detecting element. The first to third magnetic sensor parts 21 to 23 may include a pair of magnetic detecting elements connected in series as at least one magnetic detecting element. In this case, the first to third magnetic sensor parts 21 to 23 have a Wheatstone bridge circuit including a pair of magnetic detecting elements connected in series.

As shown in FIG. 3, the Wheatstone bridge circuit 211 in the first magnetic sensor part 21 includes a power source port V1, a ground port G1, an Output port E11 and a pair of magnetic detecting elements R11 and R12 connected in series. One end of the magnetic detecting element R11 is connected to the power source port V1. The other end of the magnetic detecting element R11 is connected to one end of the magnetic detecting element R12 and the output port E11. The other end of the magnetic detecting element R12 is connected to the ground port G1. A power supply voltage with a predetermined intensity is applied to the power source port V1, and the ground port G1 is connected to the ground.

The Wheatstone bridge circuit 212, in the second magnetic sensor part 22 has a configuration similar to that of the Wheatstone bridge circuit 211 in the first magnetic sensor part 21, and includes a power source port V2, a ground port G2, an output port E21 and a pair of magnetic detecting elements R21 and R22 connected in series. One end of the magnetic detecting element R21 is connected to the power source port V2. The other end of the magnetic detecting element R21 is connected to one end of the magnetic detecting element R22 and the output port E21. The other end of the magnetic detecting element R22 is connected to the ground port G2. A power supply voltage with a predetermined intensity is applied to the power source port V2, and the ground port G2 is connected to the ground.

The Wheatstone bridge circuit 213 in the third magnetic sensor part 23 has a configuration which is similar to that of the Wheatstone bridge circuits 211 and 212 in the first and second magnetic sensor parts 21 and 22, and includes a power source port V3, a ground port G3, an output port E31 and a pair of magnetic detecting elements R31 and R32 connected in series. One end of the magnetic detecting element R31 is connected to the power source port V3. The other end of the magnetic detecting element R31 is connected to one end of the magnetic detecting element R32 and the output port E31. The other end of the magnetic detecting element R32 is connected to the ground port G3. A power supply voltage with a predetermined intensity is applied to the power source port V3, and the ground port G3 is connected to ground.

In the present embodiment, as all magnetic detecting elements R11, R12, R21, R22, R31 and R32 included in the Wheatstone bridge circuits 211 to 213, an MR element, such as a TMR element or a GMR element, can be used, and it is particularly preferable to use the TMR element. The TMR element and the GMR element have a magnetization pinned layer where their magnetization direction is pinned, a free layer where their magnetization direction is changed according to a direction of the applied magnetic field, and a nonmagnetic layer arranged between the magnetization pinned layer and the free layer, respectively.

Specifically, as shown in FIG. 4, the MR element has a plurality of lower-side electrodes 41, a plurality of MR films 50 and a plurality of upper-side electrodes 42. The plurality of lower-side electrodes 41 are placed on a substrate (not shown). Each lower-side electrode 41 has along and narrow shape. A crevice is formed between two adjacent lower-side electrodes 41 in the longitudinal direction of the lower-side electrodes 41. The MR films 50 are disposed in the vicinity of both ends in the longitudinal direction on the upper surface of the lower-side electrode 41, respectively. The MR film 50 includes the free layer 51, the nonmagnetic layer 52, the magnetization pinned layer 53 and an antiferromagnetic layer 54 laminated in respective order from the lower-side electrode 41. The free layer 51 is electrically connected to the lower-side electrode 41. The antiferromagnetic layer 54 is made from an antiferromagnetic material, and fulfills the role of pinning the direction of the magnetization of the magnetization pinned layer 53 by causing exchange coupling between the magnetization pinned layer 53. A plurality of the upper-side electrodes 42 are placed on the plurality of the MR films 50, respectively. Each upper-side electrode 42 has a long and narrow shape, arranged on two lower-side electrodes 41 that are adjacent in the longitudinal direction of the lower-side electrodes 41, and electrically connects the two adjacent antiferromagnetic layers 54 on the MR films 50. Furthermore, the MR film 50 may have a configuration where the free layer 51, the nonmagnetic layer 52, the magnetization pinned layer 53 and the antiferromagnetic layer 54 are laminated in respective order from the side of the upper-side electrode 42. In the LMR element, the nonmagnetic layer 52 is a tunnel barrier layer. In the GMR element, the nonmagnetic layer 52 is a nonmagnetic conductive layer. In the TMR element and the GMR element, a resistance value varies according to an angle of the direction of the magnetization of the free layer 51 relative to the direction of the magnetization of the magnetization pinned layer 53. The resistance value is minimized when the angle is 0° (magnetization directions are parallel to each other), and is maximized when this angle is 180° (magnetization directions are anti-parallel to each other).

In FIG. 3, the magnetization directions of the magnetization pinned layers of the magnetic detecting elements R11, R12, R21, R22, R31 and R32 are indicated with a solid arrows. In the first to third magnetic sensor parts 21 to 23, the magnetization direction of the magnetization pinned layers of the magnetic detecting elements R11, R12, R21, R22, R31 and R32 is parallel to the first direction D1 (see FIGS. 1 and 2), and the magnetization direction of the magnetization pinned layers of the magnetic detecting elements R11, R21 and R31 is antiparallel to the magnetization direction of the magnetization pinned layers of the magnetic detecting elements R12, R22 and R32, respectively. In the first to third magnetic sensor parts 21 to 23, the first to third sensor signals as signals indicating an intensity of a magnetic field are output to an operation part 30 (see FIG. 5) from the output ports E11, E21 and E31 according to the change of the magnetization direction in association with the rotation of the gear wheel 10.

As shown in FIG. 5, the rotary sensing device 1 relating to the present embodiment is equipped with the operation part 30 that performs operation(s) using the first to third sensor signals S1 to S3 output from the first to third magnetic sensor parts 21 to 23, respectively. The operation part 30 is equipped with a first operation circuit 31 having two input terminals to be connected to the first magnetic sensor part 21 and the third magnetic sensor part 23, a second operation circuit 32 having two input terminals connected to the first magnetic sensor part 21 and the second magnetic sensor part 22, and a data processing part 33 having two input terminals connected to the output terminals of the first and second operation circuits 31 and 32, respectively.

The first operation circuit 31 performs operation processing using the first sensor signal S1 output from the first magnetic sensor part 21 in association with the rotation of the gear wheel 10 and the third sensor signal S3 output from the third magnetic sensor part 23, and generates a first differential signal DS1, which is the difference between these signals.

The second operation circuit 32 performs operation processing using the first sensor signal S1 and the second sensor signal S2 output from the second magnetic sensor part in association with the rotation of the gear wheel 10, and generates a second differential signal DS2, which is a difference between these signals.

The data processing part 33 determines whether the rotation direction of the gear wheel 10 is the normal rotation direction or the reverse rotation direction based upon the first and second differential signals DS1 and DS2 output from the first and second operation circuits 31 and 32, respectively.

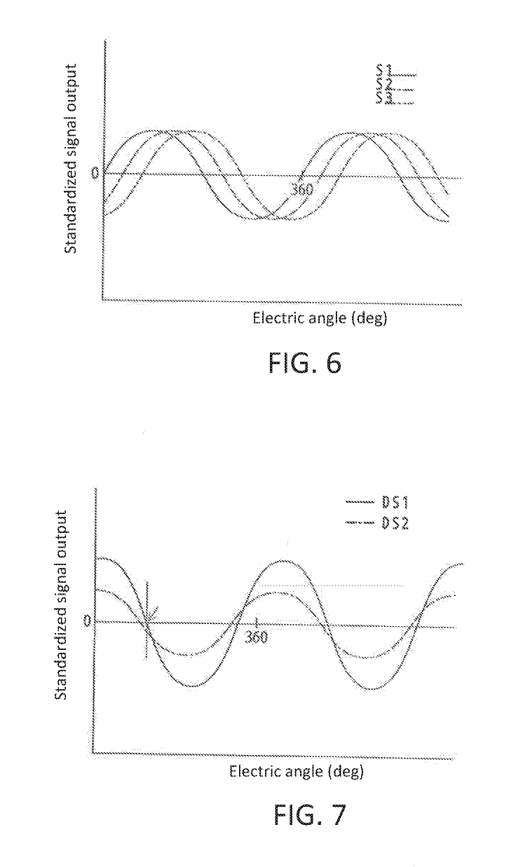

In the rotary sensing device 1 having the configuration above relating to the present embodiment, the direction of a magnetic field from the bias magnetic field generator 3 fluctuates in association with the rotation of the gear wheel 10, and the first to third sensor signals S1 to S3 are output from the first to third magnetic sensor parts 21 to 23, respectively. Specifically, as shown in FIG. 6, the first to third sensor signals S1 to S3 indicated by a sine waveform where the phase is shifted according to the relative position between the first to third magnetic sensor parts 21 to 23 and the teeth 11 of the gear wheel 10, are output. Furthermore, in FIG. 6, the horizontal axis indicates electric angles (deg) of the first to third sensor signals S1 to S3, and the vertical axis indicates the standardized signal outputs of the first to third sensor signals S1 to S3.

The first sensor signal S1 and the third sensor signal S3 are input into the first operation circuit 31, and the first operation circuit 31 generates the first differential signal DS1, which is the difference between the first sensor signal S1 and the third sensor signal S3. Further, the first sensor signal S1 and the second sensor signal S2 are entered into the second operation circuit 32, and the second operation circuit 32 generates the second differential signal DS2, which is the difference between the first sensor signal S1 and the second sensor signal S2. Specifically, as shown in FIG. 7, the first and second differential signals DS1 and DS2 indicated by waveforms with different amplitudes are generated. Furthermore, in FIG. 7, the horizontal axis indicates electric angles (deg) of the first and second differential signal DS1 and DS2, and the vertical axis indicates standardized signal output of the first and second differential signals DS1 and DS2.

The first differential signal DS1 and the second differential signal DS2 are entered into the data processing part 33, and the data processing part 33 determines whether the rotation direction of the gear wheel 10 is the normal rotation direction or the reverse rotation direction based upon the first differential signal DS1 and the second differential signal DS2, i.e., based upon the positive or negative status of the second differential signal DS2 when the first differential signal DS1 crosses zero. Specifically, the data processing part 33, for example, determines that the rotation direction of the gear wheel 10 is the normal rotation direction if the status of the second differential signal DS2 is negative when the first differential signal DS1 crosses zero from positive to negative, and determines that the rotation direction of the gear wheel 10 is a reverse rotation direction if the sign of the second differential signal DS2 is positive. In the example shown in FIG. 7, when the first differential signal DS1 crosses zero from positive to negative (in the situation indicated with the arrow in FIG. 7), because the sign of the second differential signal DS2 is negative, the data processing part 33 determines that the rotation direction of the gear wheel 10 is the normal rotation direction.

Furthermore, in the rotary sensing device 1 relating to the present embodiment, the first to third sensor signals S1 to S3 output from the first to third magnetic sensor parts 21 to 23 are entered into the data processing part 33, and the rotational position (angle of rotation) and rotary speed of the gear wheel 10 are calculated by counting the periodic number of their sensor signals S1 to S3 with the data processing part 33.

In the present embodiment, in order to generate the first differential signal DS1, the first sensor signal S1 and the third sensor signal S3 are used from the first magnetic sensor part 21 and the third magnetic sensor part 23, which are further apart among the three first to third magnetic sensors 21 to 23 in parallel. Further, in order to generate the second differential signal DS2, the first sensor signal S1 and the second sensor signal S2 are used from the first magnetic sensor part 21 and the second magnetic sensor part 22, which are the closest to each other among the first to third three magnetic sensors 21 to 23 in parallel. With this design, the amplitudes of the first differential signal DS1 and the second differential signal DS2 used for determining the rotation direction of the gear wheel 10 by the data processing part 33 can be differentiated. If the first differential signal DS1 and the second differential signal DS2 are indicated by waveforms where the amplitudes are the same and only the phases are shifted, when the gear wheel 10 rotates at high speed, the waveforms of the first and second differential signals DS1 and D2 overlap, and the rotation direction of the gear wheel 10 may be difficult to determine because the waveforms cannot be separated. However, in the present embodiment, even if the gear wheel rotates at high speed, since the first and second differential signals DS1 and DS2 will never completely overlap, the rotation direction of the gear wheel 10 can be assuredly determined.

Further, in the present embodiment, analog signals of the first differential signal DS1 generated from the first sensor signal S1 and the third sensor signal S3 and the second differential signal DS2 generated from the first sensor signal S1 and the second sensor signal S2 are processed as is by the data processing part 33 without the signals being converted into digital signals (analog signal processing by the data processing part 33). When the analog signals are converted into digital signals and the rotational state, such as a rotation direction is detected, based upon the digital signals, because an increase in noise contained in the analog signals becomes a problem, positioning of accuracy of the magnetic sensors (elements) relative to a rotating body, such as a gear wheel, or pitch accuracy of teeth or the like of the gear wheel, will affect detection accuracy of the rotation state, such as the rotation direction. In particular, when a rotating body rotates at high speed, effects of the positioning accuracy and the pitch accuracy on the detection accuracy are prominently manifested. However, as in the present embodiment, because the first and second differential signals DS1 and DS2 are processed by the data processing part 33 as is, the rotational state of a rotating body, such as a rotation direction, can be accurately detected without being influenced by the positioning accuracy of the magnetic sensors (elements) relative to a rotating body, such as a gear wheel, or the pitch accuracy of the teeth or the like of the gear wheel.

The embodiment explained above is described so as to facilitate an understanding of the present invention, and is not described so as to restrict the present invention. Therefore, each element disclosed in the embodiment above is a concept that includes all possible design changes and equivalents in the technical scope of the presentation, as well.

In the embodiment above, the mode equipped with three magnetic sensor parts (first to third magnetic sensor parts 21 to 23) was exemplified and explained, but the present invention is not limited to such a mode. For example, a mode where the first to N^{th} (N is an integer that is three or greater) magnetic sensor parts are aligned in parallel in respective order is acceptable. In this case, the first differential signal DS1 should be generated from the first sensor signal output from the first magnetic sensor part and the M^{th} sensor signal output from the M^{th} sensor signal (M is an integer that is less than or equal to N and greater than or equal to 3) magnetic sensor part, and the second differential signal DS2 should be generated from the first sensor signal and the L^{th} sensor signal output from the L^{th} sensor signal (L is an integer that is less than or equal to M-1 and greater than or equal to 2) magnetic sensor part. In other words, in the mode equipped with four or more magnetic sensor parts, if amplitudes of the first differential signal DS1 and the second differential signal DS2 are different, a combination of the magnetic sensor parts that output a sensor signal used as a basis for generating respective differential signals DS1 and DS2 is not limited, but it is preferable that at least the first differential signal DS1 is generated using the sensor signals (first sensor signal and fourth sensor signal) from the magnetic sensor parts (for example, in the case when the four magnetic sensor parts are aligned in parallel, the first magnetic sensor part and the fourth magnetic sensor part) positioned in parallel at both ends out of the magnetic sensor parts.

In the above embodiment, the rotary sensing device equipped with a gear wheel having a plurality of teeth as a rotating body was exemplified and explained, but the present invention is not limited to such a mode. For example, as the rotating body, a magnetized rotor where north poles and south poles are aligned alternately in the circumferential direction is also acceptable.

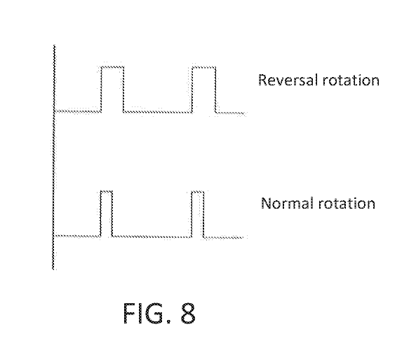

In the embodiment above, when the rotation direction of the rotating body (gear wheel 10) is determined, the data processing pail 33 may output a pulse signal (see FIG. 8) where pulse width has been changed according to whether the rotation direction is the normal rotation direction or a reverse rotation direction. For example, when the first to third sensor signals S1 to S3 from the first to third magnetic sensor parts 21 to 23 and the first and second differential signals DS1 and DS2 are entered, the data processing part 33 can output a pulse signal based upon those signals S1 to S3, and DS1 and DS2. At this time, the pulse width in the case when the rotation direction of the rotating body (gear wheel 10) is the normal rotation direction is set at 1, the rotation of an application having the rotary sensing device 1 relating to the present embodiment can be controlled based upon pulse width of the pulse signal by outputting the pulse signal where its pulse signal in the case of a reverse rotation direction is set at 2.

In the embodiment above, the data processing part 33 determines the rotation direction of the gear wheel 10 based upon the positive or negative status of the second differential signal DS2 when the first differential signal DS1 crosses zero in a direction from positive to negative, but the present invention is not limited to such a mode. For example, the rotation direction of the gear wheel 10 may be determined according to the order when the first differential signal DS1 and the second differential signal DS2 cross zero in a direction from positive to negative (or a direction from negative to positive). For example, in an example shown in FIG. 7, since the second differential signal DS2 crosses zero first in a direction from positive to negative and the first differential signal DS1 crosses next, it can be determined that the rotation direction of the gear wheel 10 is a normal rotation direction.

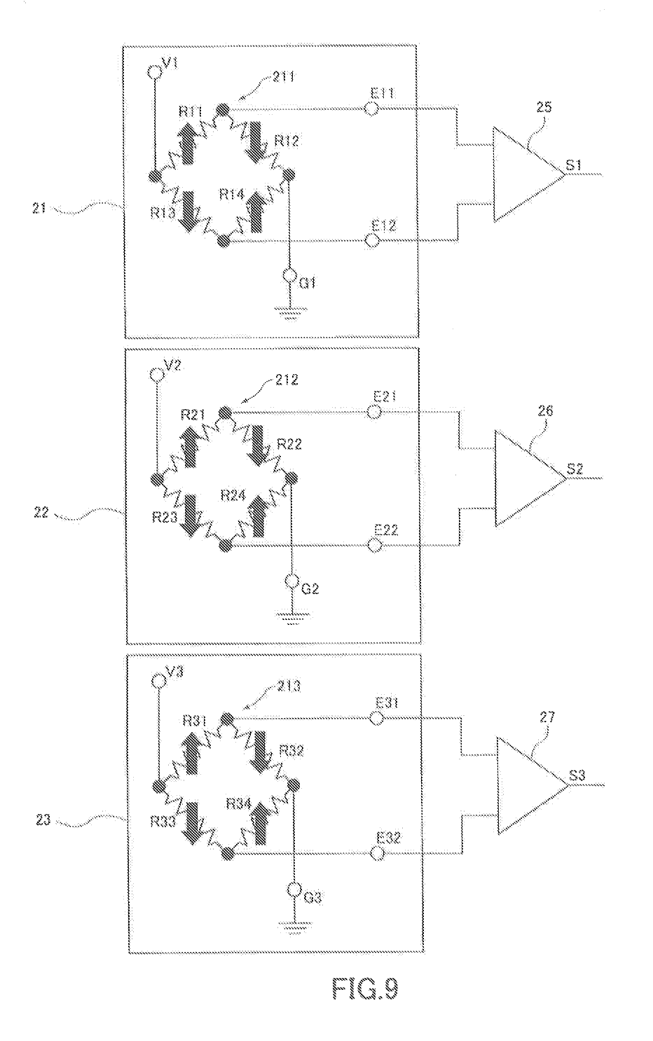

In the embodiment above, the mode where the Wheatstone bridge circuits 211 to 213 in the first to third magnetic sensor parts 21 to 23 include the output ports E11 to E13 and a pair of magnetic detecting elements R11 and R12, R21 and R22 and R31 and R32, respectively, was described but the present invention should not be limited to such mode. For example, as shown in FIG. 9, the Wheatstone bridge circuits 211 to 213 may include two output ports E11 and E12, E21 and E22 and E31 and E32, a first pair of magnetic detecting elements R11 and R12, R21 and R22 and R31 and R32 connected in series, and a second pair of magnetic detecting elements R13 and R14, R23 and R24 and R33 and R34 connected in series, respectively. In this case, ends of the magnetic detecting elements R11 and R13, R21 and R23 and R31 and R33 are connected to the power source ports V1 to V3, respectively. Each of the other ends of the magnetic detecting elements R11, R21 and R31 are connected to one end of the magnetic detecting elements R12, R22 and R33 and the output ports E11, E21 and E31, respectively. The other ends of the magnetic detecting elements R13, R23 and R33 are connected to one end of the magnetic detecting elements R14, R24 and R34 and the output ports E12, E22 and E32, respectively. Each of the other ends of the magnetic detecting elements R12 and R14, R22 and R24 and R32 and R34 are connected to the ground ports G1 to G3, respectively.

Then, the magnetization directions (indicated with solid arrows in FIG. 9) of the magnetization pinned layers of the magnetic detecting elements R11 to R14, R21 to R24 and R31 to R34 are parallel to the first direction D1 (see FIGS. 1 and 2), and the magnetization directions of the magnetization pinned layers of the magnetic detecting elements R11, R14, R21, R24, R31 and R34 and the magnetization directions of the magnetization pinned layers of the magnetic detecting elements R12, R13, R22, R23, R32 and R33 are anti-parallel to each other. In the first to third magnetic sensor parts 21 to 23, the potential difference of the output ports E11 and E12, E21 and E22 and E31 and E32 varies according to the change in the magnetization direction in association with the rotation of the gear wheel 10, a signal indicating the intensity of a magnetic field is output, and the signals can be output to the operation part 30 (see FIG. 5) from difference detectors 25, 26 and 27 as the first to third sensor signals S1 to S3, respectively.

### DESCRIPTION OF SYMBOLS

1 . . . rotary sensing device
2 . . . magnetic sensor
21 . . . first magnetic sensor part
22 . . . second magnetic sensor part
23 . . . third magnetic sensor part
30 . . . operation part (rotation direction detecting part)
31 . . . first operation circuit (rotation direction detecting part)
32 . . . second operation circuit (rotation direction detecting part)
33 . . . data processing circuit (rotation direction detecting part)
10 . . . gear wheel (rotating body)
11 . . . teeth

What is claimed is:

1. A rotary sensing device, comprising:
first to N^{th} sensor elements (N is an integer that is 3 or greater)that oppose a rotating body, which is rotatable in a normal rotation direction and a reverse rotation direction, that are sequentially aligned along the rotation direction of the rotating body, and that output first to N^{th} sensor signals based upon rotation of the rotating body, respectively, and
a rotation direction detecting part that detects the rotation direction of the rotating body based upon the first to N^{th} sensor signals output from he first to N^{th} sensor elements, wherein
the rotation direction detecting part detects the rotation direction of the rotating body from a first differential signal obtained from the first sensor signal and the M^{th} (M is an integer that is less than or equal to N and greater than or equal to 3 sensor signal and a second differential signal obtained from the first sensor signal, and an L^{th} sensor signal (L is an integer that is less than or equal to M-1 and greater than or equal to 2).

2. The rotary sensing device according to claim 1, wherein
N is 3, and
the rotation direction detecting part detects the rotation direction of the rotating body based upon the first differential signal obtained from the first sensor signal and the third sensor signal, and the second differential signal obtained from the first sensor signal and the second sensor signal.

3. The rotary sensing device according to claim 2, wherein
the gap between the first sensor element and the second sensor element is smaller than the gap between the second sensor element and the third sensor element.

4. The rotary sensing device according to claim 1, wherein
the rotation direction detecting part detects the rotation direction of the rotating body based upon a positive or negative status of the second differential signal when the first differential signal crosses zero.

5. The rotary sensing device according to claim 1, wherein
the rotation direction detecting part detects the rotation direction of the rotating body based upon the positive or negative status before and after the first differential signal crosses zero and the positive or negative status of the second differential signal when the first differential signal crosses zero.

6. The rotary sensing device according to claim 1, wherein
the rotating body is a gear wheel comprising a plurality of teeth made from a magnetic material, and
a gap between the first sensor element and the N^{th} sensor element is smaller than a gap of two adjacent teeth of the gear wheel.

7. The rotary sensing device according to claim 1, wherein
the rotating body comprises a plurality of north poles and south poles that are aligned alternately in a circumferential direction, and
a gap between the first sensor element and the N^{th} sensor element is smaller than a gap between two adjacent north poles.

8. The rotary sensing device according to claim 1, wherein
the first to N^{th} sensor elements are comprise TMR elements or GMR elements.
